(19) United States
(12) Patent Application Publication
(10) Pub. No.: US 2006/0224956 A1
(43) Pub. Date: Oct. 5, 2006

(54) Intelligent document saving

(75) Inventors: Adrian Storisteanu, Toronto (CA); Kushal Sayeed Munir, Toronto (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/098,988

(22) Filed: Apr. 5, 2005

(51) Int. Cl. G06F 17/24

(52) U.S. Cl. 715/530

(57) ABSTRACT

A method, system, and apparatus for intelligent document saving. An intelligent document saving method can include cropping a document to frame a changed portion of the document and saving only content framed by the cropping. Notably, the cropping step can include maintaining watermarks in the document to demarcate unchanged portions from both the start and the end of the document and, consequently, a starting and ending position in the document of the changed portion. The position of the watermarks can be repeatedly updated whenever changes are performed to the document.

### BACKGROUND OF THE INVENTION

1. Statement of the Technical Field

The present invention relates to a text editor and more particularly to a file save operation in a text editor.

2. Description of the Related Art

Document editing remains a foundation function of computing technology. A core personal productivity application, the document editor can be found in almost every desktop computing system today. Generally, in a conventional text editor, a text document can be loaded into a buffer and changes can be applied to document in the buffer, which can include additions, deletions and modifications to the text. Periodically, the buffer can be flushed to persistent storage so that the changes to the document can be preserved.

Importantly, the saving of a document to persistent storage can occur not only manually at the behest of an operator, but also automatically in the course of an “auto-save” operation. In the typical auto-save operation, the saving of a document can be triggered periodically according to a default interval or according to a user specified interval. In this way, unexpected disruptions in the operation of the host computing platform, such as a power failure, need not necessarily result in the unanticipated loss of changes to the document which may have occurred since the last manually specified save operation.

The advent of wide scale computer communications networks has changed the face of modem computing such that computing applications no longer are limited to the desktop. Today, vast computing architectures support remote computing through clients as small as a wrist watch and as complex as a workstation. Remote computing devices can host any number of end user applications, including document editors. In some circumstances, the remote computing devices can host the document editor logic itself and a centralized data store can be used to park edited documents. In other circumstances, the remote computing devices can receive the document editor logic from a remote server and edited documents can be stored locally, or remotely, or both.

Despite advances in distributed computing, the problem of saving edited documents frequently to avoid data loss remains. Just like the simplified, desktop computing paradigm, in a distributed arrangement, edited documents can be saved automatically at periodic intervals. Unlike the desktop paradigm, however, additional challenges can inhibit the flexible auto-saving of data. Most notably, auto-saving a large document can consume an inordinate amount of network bandwidth which can interject unwanted delays pending the completion of the auto-save operation. Also, a protracted auto-save operation can become vulnerable to unexpected communications losses. Hence, auto-saving a document in the distributed computing paradigm can be problematic.

### SUMMARY OF THE INVENTION

The present invention addresses the deficiencies of the art in respect to saving a document in a document editing session and provides a novel and non-obvious method, system and apparatus for intelligent document saving. In this regard, an intelligent document saving method can include cropping a document to frame a changed portion of the document and saving only content framed by the cropping. Notably, the cropping step can include maintaining watermarks in the document to demarcate a starting and ending position in the document of the changed portion.

Specifically, first an end of unchanged text watermark can be recorded as a last position in the document at which a contiguous portion of unchanged content exists beginning from the end of the document. Second, a start of unchanged text watermark can be recorded as a last position in the document at which a contiguous portion of unchanged content exists beginning from the start of the document. In any event, the position of the watermarks can be repeatedly updated whenever changes are performed to the document. For instance, a position of each of the start of unchanged text and the end of unchanged text watermarks can be repeatedly updated whenever changes are performed to the document.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an intelligent document saving system configured for intelligent document saving in a remote editing session;

FIG. 2 is a pictorial illustration of a cropping process utilized in an intelligent document saving system; and,

FIG. 3 is a flow chart illustrating a process for adjusting watermarks for cropping a changed region of a document in an intelligent document saving system.

### DETAILED DESCRIPTION OF THE PREFERRED EMBODIMENTS

The present invention is a method, system and apparatus for intelligent document saving. In accordance with the present invention, a document can be cropped to exclude unmodified portions of the document at the beginning and end of the document. Document watermarks can be established to demarcate the boundaries between the unmodified portions of the document and the modified portion. Subsequently, during a save operation, only the cropped portion of the document can be processed for saving. In this way, the saving of a document need not consume unnecessary computing resources as would be the case were the entire document to have been processed for saving. In particular, in a remote document editing session, substantially less network bandwidth will be required to effectuate save and auto-save operations.

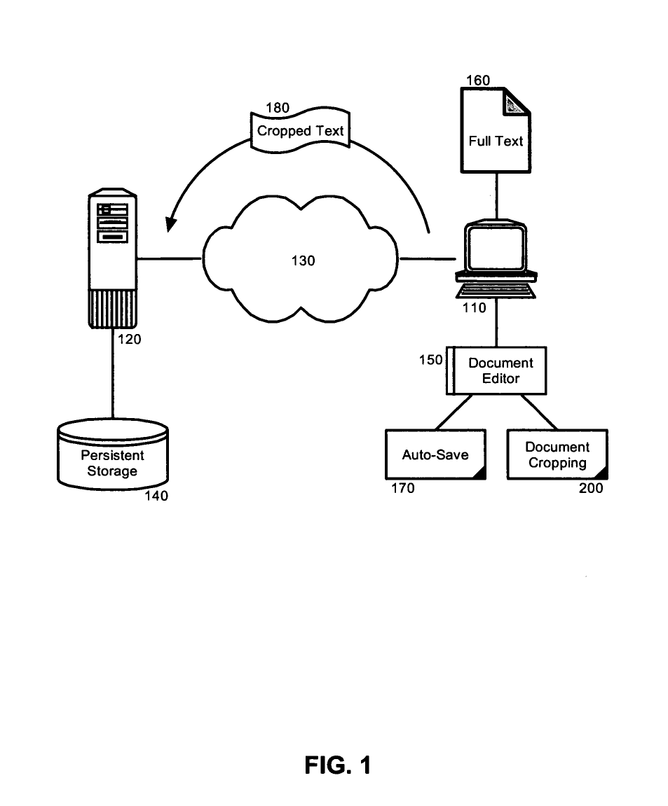

In further illustration, FIG. 1 depicts an intelligent document saving system which has been configured for intelligent document saving in a remote editing session. The remote editing session can include a client computing platform 110 communicatively coupled to a server computing platform 120 over a computer communications network 130. The client computing platform 110 can include logic implementing a document editor 150. In this regard, the logic implementing the document editor 150 can be accessed directly from within the client computing platform 110, or remotely from the server computing platform 120 or any other remote logic source.

The document editor 150 can be programmed to edit a document 160. The document 160 can be a document persisted locally in the client computing platform 110, or remotely in the persistent storage 140 of the server computing platform 120. As part of the document editing session, a cropped portion 180 of the document 160 can be saved to persistent storage 140 in the server computing platform 120. (It will be recognized by the skilled artisan, however, that the cropped portion 180 of the document 160 can be saved locally to the client computing platform 110). In any case, the cropped portion 180 can be saved to persistent storage 140 either in response to a manually instituted save operation, or in response to an auto-save process 170 coupled to or included as part of the document editor 150. To produce the cropped portion 180 of the document 160, a document cropping process 200 further can be coupled to or included as part of the document editor 150.

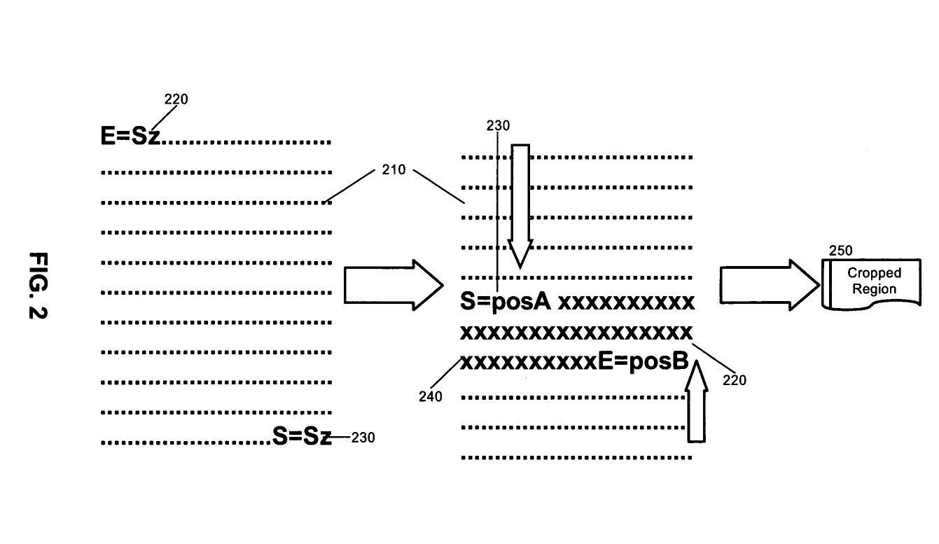

More specifically, FIG. 2 is a pictorial illustration of a cropping process utilized in an intelligent document saving system. As shown in FIG. 2, a base document 210 of unchanged content can be demarcated by two watermarks 220, 230—an end of unchanged text watermark 220 and a start of unchanged text watermark 230. The end of unchanged text watermark 220 can indicate the end of a contiguous block of unchanged content in the base document 210, from the end of the base document 210 to the last position in the document where a change has occurred. Conversely, the start of unchanged text watermark 230 can indicate the end of a contiguous block of unchanged content in the base document 210, from the start of the base document 210 to the first position in the document where a change has occurred.

Applying the watermarks 220, 230, when a portion 240 of the base document 210 is modified, either through the addition, deletion, or modification of text, the end of unchanged text watermark 220 can be lowered to the last position in the base document 210 where the modified portion 240 of the base document 210 ends and where the unmodified portion begins. Likewise, the start of unchanged text watermark 230 can be raised to the first position in the base document 210 where the modified portion 240 starts and where the unmodified portion of the base document 210 ends. In this way, a cropped region 250 of the base document 210 can be produced to exclude the unchanged top and bottom portions of the base document 210. The watermark positions can be implemented either to indicate text element counts, or to indicate text character counts, in the document content, as it best applies to the internal implementation of the document editor.

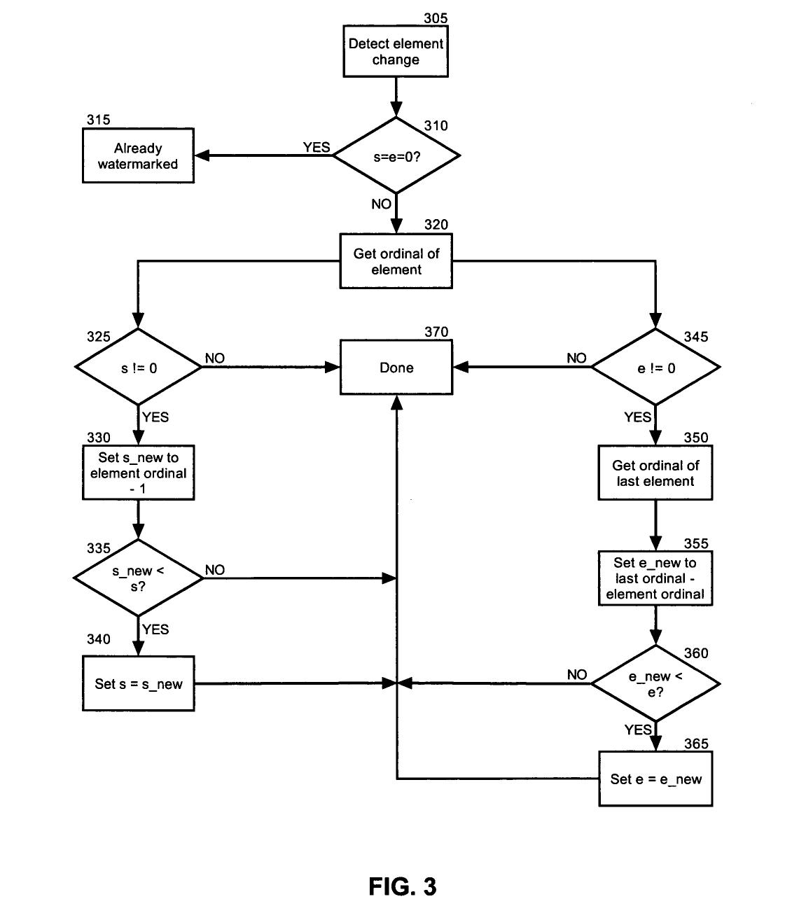

In more particular illustration, FIG. 3 is a flow chart illustrating a process for adjusting watermarks for one changed text element for cropping a changed region of a document in an intelligent document saving system. All editing change operations in a document consist of one or more text element changes, insertions, and deletions. Beginning in block 305, a text element change event can be detected in the base document. In decision block 310, it can be determined whether the start watermark and end watermark are both equal to zero, indicating that the base document already has been watermarked in its entirety and that the complete base document must be saved in block 315. In contrast, where the start watermark is equal to the end watermark and where both are equal to the number of text elements in the original document, no changes will have been effected to the base document and a save will not be necessary. In this regard, the end watermark can be valued as a position which increases as one traverses the document from the end of the document to the beginning of the last contiguous region of unchanged content. In contrast, the start watermark can be valued as a position which increases as one traverses the document from the beginning of the document to the first position in a region of changed content.

If it is determined that the document is to be processed with a new placement of start and end watermarks, in block 320 the ordinal of the changed element can be determined. Once the ordinal for the changed element has been determined, in blocks 325 through 340, the start watermark can be repositioned, while in blocks 345 through 365, the end watermark can be repositioned. Taking first the start watermark, in decision block 325, if the start watermark position is zero, there will have been no unchanged text elements at the beginning of the document, and no further adjustments to the start watermark will be required. Otherwise, if the start watermark is not zero, in block 330 a new start count can be computed according to the ordinal of the first element, less one position. If the newly computed start count is less than the current start watermark, the start watermark can be set to the value of the newly computed start count.

In a similar fashion, the end watermark can be repositioned in the base document. Specifically, in decision block 345, if the end watermark position is zero, there will have been no unchanged text elements at the end of the document, and no further adjustments to the end watermark will be required. However, if the end watermark is not zero, in block 350 the ordinal of the last element in the document, which is the new count of elements in the changed document, can be determined. In block 355, a new end count can be computed according to the ordinal of the last element, less the ordinal of the changed element. If the newly computed end count is less than the current end watermark, the end watermark can be set to the value of the newly computed end count. In this way, the watermarks can indicate a boundary of a region of unchanged content which frames a region of changed content in the document.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. An intelligent document saving method comprising the steps of:
cropping a document to frame a changed portion of said document; and,
saving only content framed by said cropping.

2. The method of claim 1, wherein said cropping step comprises the step of maintaining watermarks in said document to demarcate a starting and ending position in said document of said changed portion.

3. The method of claim 2, wherein said maintaining step comprises the steps of:
first recording an end of unchanged text watermark at a last position in said document at which a contiguous portion of unchanged content exists beginning from an ending position of said document; and,
second recording a start of unchanged text watermark at a last position in said document at which a contiguous portion of unchanged content exists beginning from a starting position of said document.

4. The method of claim 2, further comprising the step of repeatedly updating a position of said watermarks whenever changes are performed to said document.

5. The method of claim 3, further comprising the step of repeatedly updating a position of each of said start of unchanged text and said end of unchanged text watermarks whenever changes are performed to said document.

6. The method of claim 1, wherein said saving step comprises the step of auto-saving only content framed by said cropping.

7. The method of claim 1, wherein said saving step comprises the step of forwarding only content framed by said cropping to a remote server to backup said document.

8. An intelligent document saving system comprising:
a document editor;
document save logic coupled to said document editor; and,
document cropping logic linked to said document editor and programmed to provide a cropped portion of a document for saving by said document save logic.

9. The system of claim 8, wherein said document save logic is auto-save logic.

10. The system of claim 8, wherein said document save logic comprises programming to provide said cropped portion of said document to remote persistent storage.

11. The system of claim 8, wherein said document cropping logic comprises programming to record watermarks in said document to demarcate a starting and ending position in said document of a changed portion of said document.

12. A machine readable storage having stored thereon a computer program for intelligent document saving, the computer program comprising a routine set of instructions which when executed by a machine causes the machine to perform the steps of:
cropping a document to frame a changed portion of said document; and,
saving only content framed by said cropping.

13. The machine readable storage of claim 12, wherein said cropping step comprises the step of maintaining watermarks in said document to demarcate a starting and ending position in said document of said changed portion.

14. The machine readable storage of claim 13, wherein said inserting step comprises the steps of:
first recording an end of unchanged text watermark at a last position in said document at which a contiguous portion of unchanged content exists beginning from the an ending position of said document; and,
second recording a start of unchanged text watermark at a last position in said document at which a contiguous portion of unchanged content exists beginning from a starting position of said document.

15. The machine readable storage of claim 13, further comprising an additional set of instructions which when executed by the machine causes the machine to further perform the step of repeatedly updating a position of said watermarks whenever changes are performed to said document.

16. The machine readable storage of claim 14, further comprising an additional set of instructions which when executed by the machine causes the machine to further perform the step of repeatedly updating a position of each of said start of unchanged text and said end of unchanged text watermarks whenever changes are performed to said document.

17. The machine readable storage of claim 13, wherein said saving step comprises the step of auto-saving only content framed by said cropping.

18. The machine readable storage of claim 13, wherein said saving step comprises the step of forwarding only content framed by said cropping to a remote server to backup said document.
